(19) United States
(12) Patent Application Publication
(10) Pub. No.: US 2001/0005831 A1
(43) Pub. Date: Jun. 28, 2001

(54) System for providing services through the internet

(76) Inventors: Asaf Lewin, Nordia (IL); Flora Lewin, Nordia (IL); Mordechai Krispil, Alfey Menashe (IL)

Correspondence Address: OLIFF & BERRIDGE PLC, P.O. Box 19928, Alexandria, VA, 22320, US

(21) Appl. No.: 09/737,762

(22) Filed: Dec. 18, 2000

(30) Foreign Application Priority Data
Dec. 16, 1999 (IL) 133546

(51) Int. Cl. G06F 17/60

(52) U.S. Cl. 705/5; 705/16

(57) ABSTRACT

A network integrated computer system allowing a consumer to find a provider of a product or service through a communication network is described. The system provides an efficient mechanism through which a consumer can search PoS (products or services) based on the availability of the PoS and other criteria that are unique to the required PoS. After finding a PoS that meets the date/time requirements and other criteria set by the consumer, the consumer may then submit a reservation order via the system. The provider of the above PoS is notified by the system of the new reservation order. The system enables the provider to confirm or reject the reservation order and after doing so the consumer is notified by the system of the confirmation or rejection of the reservation order.

### FIELD OF THE INVENTION

This invention relates to electronic commerce and, in particular, to methods and software for searching and booking products or services of resource limited nature.

### BACKGROUND OF THE INVENTION

The following patents are examples of the relevant prior art:

| U.S. Pat. No. | Issued | Title |
|---|---|---|
| US 5926793 | 20/7/1999 | Digital-timeshare-exchange |
| US 5878416 | 2/3/1999 | Automated system and method for matching an item |
| | | of business property to a recipient |
| US 5963913 | 5/10/1999 | System and method for scheduling an event subject |
| | | to the availability of requested participants |
| US 5960406 | 28/9/1999 | Scheduling system for use between users on the web |
| US 5970466 | 19/10/1999 | Graphical computer system and method for |
| | | appointment scheduling |

In daily life, it is often required to book an appointment, with service providers such as, inter alia, beauty salons, veterinarians, plumbers or technicians. In addition, people book places for units on a resource-limited basis (such as lodging or golf courses).

Currently, customers usually schedule such appointments and events by contacting the service providers by telephone, fax, or email. Prior to the scheduling act, the customers must search for the suitable service provider that is available and suites their interests. Usually this search is carried out by manually contacting each provider by using a service provider list, e.g. directory services, yellow pages, etc.

As is well known, there has been an explosive growth in the use of the Internet, and in particular of the World Wide Web (WWW) interface, which is one of the facilities provided by the Internet. The WWW comprises many pages or files of information that may be distributed across many different computers linked by the Internet. Information stored on such pages can be, for example, details of a service or product provider, contact data, information about the services and products and various news. Many customers started using the Internet, to search for service providers in the required category. Thus, for example online Yellow pages on the Web as well as most of other web portals are limited by presentation only of a list of service providers in a required category and geographical zone. However, the user would prefer to get a list filtered by availability of the product or service and other specific parameters.

Some Internet applications, e.g. WorldRes.com, provide Web based information systems only for specific categories, such as hotel reservations, golf courts reservations, etc., but they do not address the need of the business provider to manage his resources and schedule online, confirm/reject the reservation, or manage his customers and employees, they only focus on the search of the above specific categories based on availability.

A similar problem exists when people want to schedule meetings or other events. Despite that the technical field of scheduling is a wide field in which many systems currently exist, most of the conventional scheduling systems, e.g. Xtime and ClickSoftware, are only mathematical “engines” that optimize the allocation of limited group of resources for a prioritized group of tasks, e.g., for scheduling technicians for a number of house calls. Such scheduling engines do not deal with many aspects of the service for which they were used to schedule. As well as WorldRes, these systems are focused at the actual scheduling algorithms, which basically involve such information as required resources, task priority, and task duration.

Thus, there is accordingly a need in the art for a system providing business facilities to a user, such as seeking, booking, confirming availability of numerous number of types of services and products in various lines of business, scheduling events between users, and other facilities. Such a system, instead of solving only the issue of availability, would enable a consumer to search, compare and select a provider that most perfectly matches customer's needs. The selection may be based on a plurality of criteria, such as availability of the provider, his skills, price, location, ranking, previous experience and so like.

### SUMMARY OF THE INVENTION

The aforementioned problems are met and the needs are solved by providing a network integrated computer system allowing a consumer to find a provider of a product or service. The consumer may search, book and confirm reservations for a wide range of services and intangible products, and also allowing unlimited variety of service providers to receive and manage online reservations world-wide via a communication network, preferably, the internet.

The terms “booking” and “reservation” will be used interchangeably throughout this document. The term “PoS” that will be used throughout the description and claims stands for “Products or Services”. The term “business” where it is used in the description and in the claims refers to a provider of PoS.

Each PoS is associated with at least a general criterion and a specific PoS-related criterion, that will be explained in details hereinafter. In this documents for the computerized method and system of the present invention these criteria are referred to as general and specific filter criteria, respectively.

The terms “customer” and “consumer” will be used interchangeably throughout this document. The term “reservation order” will be used throughout this document to describe a request by a consumer to book an appointment, e.g. in a beauty saloon, or reserve a product, e.g. Bed and Breakfast.

It is noted that the examples and specific system architectures described below do not limit the present invention in any way and a multitude of additional PoS's, Web interfaces and systems are within the scope of the present invention.

Whilst the invention is applicable to any communication networks, it will be described hereinafter specifically with reference to the Internet and even more specifically to the WWW, that also will shortly be referred to Web.

The system constitutes a consumer user interface that is generated, for example, in a known per se page markup syntax utilizable by known per se Web browsers for allowing consumers to communicate with the system of the present invention.

There will now be described a typical but not exclusive example of a sequence of operations for consumer's search for a business and performing online booking of services in accordance with a preferred embodiment of the present invention.

Upon selection of a type of PoS by the consumer, the system of the present invention presents the consumer with a “search” form which includes (i) the general filter criteria for the search and (ii) the specific filter criteria () that are related to the chosen type of PoS. The general filter criteria includes SIC (Service Industry Code), Location (Country/City/Zip code), Requested Time (Start date/End date, Start time/End time), Time preferences (i.e. As early as possible/As late as possible/No preferences), Price range (Maximum price), Provider ranking range (Minimum ranking of the provider based on customer survey), Previous experience of the consumer with the provider (is the provider listed in the consumer's “favorites” list). The specific filter criteria includes entities that represent services and entities that represent features or attributes of the requested service.

For example, the search form for a Bed and Breakfast (first type of PoS) may require the consumer to enter such specific information as the number of adults and the number of children, while the search form for a veterinarian (second type of PoS) may require the consumer to enter a type of the pet.

It should be noted that the mechanism for presenting for each PoS type the specific search presentations based on the general and specific filter criteria and search result presentations is a part of the mechanism that is referred in this document to the “Social interface” mechanism. The “Social interface” mechanism relates also to the interface used during business registration and setup changes described later on in this document. Specifically, for the Web applications, said presentations may be implemented as Web forms.

Upon submission of the search form by the consumer utilizing the social interface of the present invention, the system matches PoS to the filter criteria set by the consumer (criteria such as: availability of the provider, his skills, price, location, ranking, previous experience, and so like). The availability criteria of the PoS is tested by checking, e.g. whether the PoS has any available, such as unreserved, time slots in the time interval, i.e. “start date/time” and “end date/time”, specified by the consumer for the resources required in order to provide the PoS.

As a result of processing by the system the input information submitted by the consumer, the consumer (as a result of the search) is presented with a contact information of potential provider(s) that provide a resource limited product or service. The consumer may select any of the matching PoS and generate a reservation order using the user interface provided by the system. The reservation order is stored in the system database and triggers at least one notification to the corresponding provider in the form of, for example, mail, fax, pager, or cellular phone message. Preferably, the consumer receives a status indication in respect of the reservation order. The status indication may include, for example confirmation or rejection.

There will now be described a typical but not exclusive example of a sequence of operations for a new business registration in accordance with a preferred embodiment of the present invention.

Whenever a new provider wishes to use the system of the present invention, in order to propose his PoS through the system, the provider is presented with a welcome page, where he is requested to indicate his PoS types, e.g. by selection from a predefined list. As a result, the system presents “registration” forms, which should be filled out by the provider.

The “registration” forms contain general data, e.g. Business name, Business address. The provider is required to select in this form which services or products he wishes to provide through the system, e.g. by selection from a predefined list or adding custom services.

For each service or product the provider may set custom data, such as description and typical service duration. Additionally, the provider is required to select which of the service's related attributes are relevant in his business for each service or product. Again, this selection may be carried out from a predefined list or by adding custom attributes. Further, the provider is requested to specify what types of resource he wishes the system to manage for him, e.g. by selection from a predefined list or by adding custom types. For each service he/she sets the quantity and types of resources required to perform the service. In the next step, the provider specifies his/her regular working hours, out of the office periods and holidays.

During the last step the provider specifies how he/she would like to price his services, e.g. which the attributes influence the price, in what manner the price is influenced, and the actual prices, again, based on a prederfined list of possible pricing methods.

During the registration process, all the industry related information is read from the Industry Templates that were fed into the system in advance, and all the business specific information is gathered and stored in the business database. At the end of this process the new Business is registered and ready to be presented and reserved by consumers.

At any time of exploitation of the system of the present invention, the provider may view the status of one or more reservation orders assigned to his products or services using the user interface provided by the system via Web or via the provider client software that is a part of the system. The system gives the provider an interface to confirm, reject, postpone (add to waiting list) or put on hold (for any reason) reservation orders. Each of the above possibilities leads to notifications sent by the system to the respective consumer.

The system of the present invention has many of the advantages of the conventional Web integrated systems and additional novel features such as the system supports substantially unlimited variety of service providers and products, the system is capable of adapting the “personality” of each type of product or service together with its unique properties, using the aforementioned “social interface” mechanism. Thus providing the consumer with a comprehensive and easy to use interface for each type of product or service. For example, the forms related to golf courts look and behave like a customary golf reservation system and the forms generated for bed and breakfasts look and behave like a customary bed and breakfast reservation system, etc.

The system is preferable integrated into Web sites which include a database of PoS providers, such as Portals, yellow pages, directory services of various sorts, thus enriching those Web sites with search capabilities on availability basis and enabling consumers to perform online reservation of PoS via the system. The system obviates the need for manual search of most suitable and available PoS, by providing consumers with a tool for automatic search and availability, and booking of such PoS.

Hence, according to abroad aspect of the present invention, there is provided a computerized method for finding at least one provider that provides resource limited product or service (PoS) through a communication network; the PoS is associated with at least a general criterion and a specific PoS-related criterion; the method comprising the steps of:

a customer submitting as an input, through a social interface at least one PoS and associated general and specific PoS-related criterion of interest in respect of each one of said at least one PoS;

processing the input in order to find the respective contact information of at least one provider that meet said at least one PoS and said at least a general criterion and a specific PoS-related criterion of interest;

presenting the contact information obtained in step (b).

According to a preferred embodiment of the present invention, the system for finding at least one provider further comprising the steps of:

selecting at least one from among said providers and generating a reservation order therefor; and

receiving a status indication in respect of said order; said status indication includes at least confirmation or rejection.

According to another broad aspect of the present invention, there is provided a computerized method for registration at least one provider that provides resource limited product or service (PoS) through a communication network; the PoS is associated with at least a general criterion and a specific PoS-related criterion; the method comprising the steps of:

presenting the provider with a welcome Web page, where the provider is requested to indicate his PoS type;

indicating the provider's PoS type;

presenting to the provider a registration form;

the provider selecting the in the form which services or products he wishes to provide;

the provider select in the form which of the service's related attributes are relevant in his business for each PoS;

the provider specifying in the form what types of resource required for each PoS;

the provider specifying in the form his working hours;

the provider specifying in the form a way of pricing.

According to another broad aspect of the present invention, there is provided a computerized system for finding at least one provider that provides resource limited product or service (PoS) through a communication network; the PoS is associated with at least a general criterion and a specific PoS-related criterion; the system comprising:

at least one customer workstation linked to said communication network, configured to submit as an input through a social interface, at least one PoS and associated general and specific PoS-related criterion of interest in respect of each one of said at least one PoS;

a server environment linked to said communication network, configured to process the input in order to find the respective contact information of at least one provider that meet the at least one PoS and said at least a general criterion and a specific PoS-related criterion of interest;

said customer workstation being further configured to present the contact information obtained in step (b).

According to the preferred embodiment of the invention the system in response to selecting at least one from among said providers, the server environment is configured to generate a reservation order therefor; and said at least one consumer workstation is further configured to receive a status indication in respect of said order; said status indication includes at least confirmation or rejection.

According to yet another broad aspect of the present invention, there is provided a computerized program storage device readable by machine, tangibly embodying a program of instructions executable by the machine to perform method steps for finding at least one provider that provides resource limited product or service (PoS) through a communication network; the PoS is associated with at least a general criterion and a specific PoS-related criterion; the method comprising:

a customer submitting as an input, through a social interface at least one PoS and associated general and specific PoS-related criterion of interest in respect of each one of said at least one PoS;

processing the input in order to find the respective contact information of at least one provider that meet said at least one PoS and said at least a general criterion and a specific PoS-related criterion of interest;

presenting the contact information obtained in step (b).

According to still another broad aspect of the present invention, there is provided a computerized program storage device readable by machine, tangibly embodying a program of instructions executable by the machine to perform method steps for registration at least one provider that provides resource limited product or service (PoS) through a communication network; the PoS is associated with at least a general criterion and a specific PoS-related criterion; the method comprising the steps of:

presenting the provider with a welcome Web page, where the provider is requested to indicate his PoS type;

indicating the provider's PoS type;

presenting to the provider a registration form;

the provider selecting the in the form which services or products he wishes to provide;

the provider select in the form which of the service's related attributes are relevant in his business for each PoS;

the provider specifying in the form what types of resource required for each PoS;

the provider specifying in the form his working hours;

the provider specifying in the form a way of pricing.

According to further broad aspect of the invention, there is provided a computerized computer program product comprising a computer useable medium having computer readable program code embodied therein for finding at least one provider that provides resource limited product or service (PoS) through a communication network; the PoS is associated with at least a general criterion and a specific PoS-related criterion; the computer program product comprising:

computer readable program code for causing the computer to a customer submitting as an input, through a social interface at least one PoS and associated general and specific PoS-related criterion of interest in respect of each one of said at least one PoS;

computer readable program code for causing the computer to process the input in order to find the respective contact information of at least one provider that meet said at least one PoS and said at least a general criterion and a specific PoS-related criterion of interest;

computer readable program code for causing the computer to present the contact information obtained in step (b).

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1A is a general diagram of the architecture of the system in accordance with a preferred embodiment of the present invention.

FIG. 1B is a detailed block diagram of the interaction via WWW between the user workstation, provider workstation and various servers of the system in accordance with a preferred embodiment of the present invention.

FIG. 1C is a detailed block diagram of the Web Server in accordance with a preferred embodiment of the present invention.

FIG. 1D is a detailed block diagram of the Messaging Server in accordance with a preferred embodiment of the present invention.

FIG. 1E is a detailed block diagram of the Synchronization Server in accordance with a preferred embodiment of the present invention.

FIG. 1F is a detailed block diagram of the administration in accordance with a preferred embodiment of the present invention.

FIG. 1G is a detailed block diagram of the Provider Business Setup in accordance with a preferred embodiment of the present invention.

FIG. 1H is a detailed block diagram of the Provider Business Center subsystem in accordance with a preferred embodiment of the present invention.

FIG. 2A illustrates a schematic diagram of “Industry Templates” related data in accordance with a preferred embodiment of the present invention.

FIG. 2B illustrates continuation of FIG. 2A.

FIG. 2C illustrates a schematic diagram of “Business” related data in accordance with a preferred embodiment of the present invention.

FIG. 2D illustrates continuation of FIG. 2C.

FIG. 3A is a flow illustrating the process of new business registration in accordance with a preferred embodiment of the present invention.

FIG. 3B is a flow illustrating the process whereby consumers search for a business and performing online booking of a service in accordance with a preferred embodiment of the present invention.

### DETAILED DESCRIPTION OF THE INVENTION

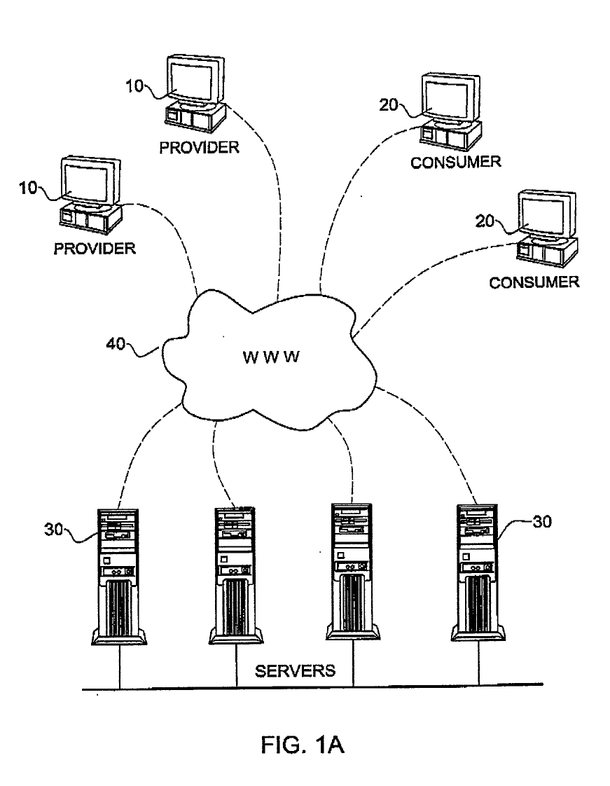

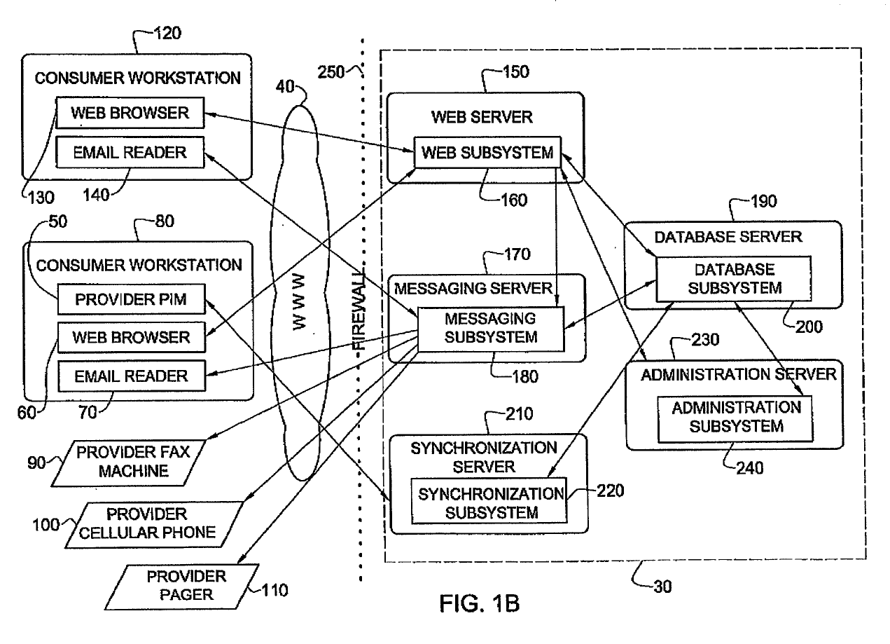

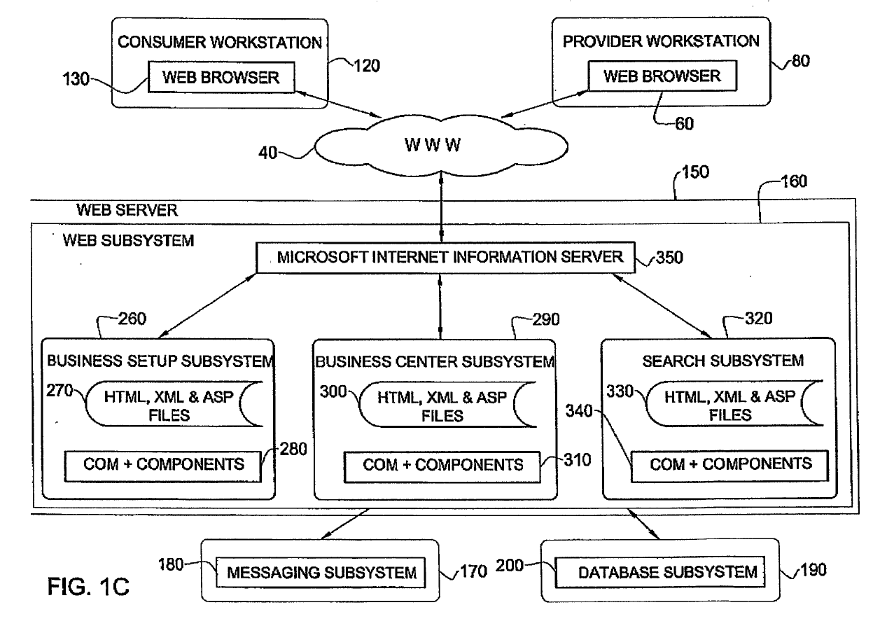

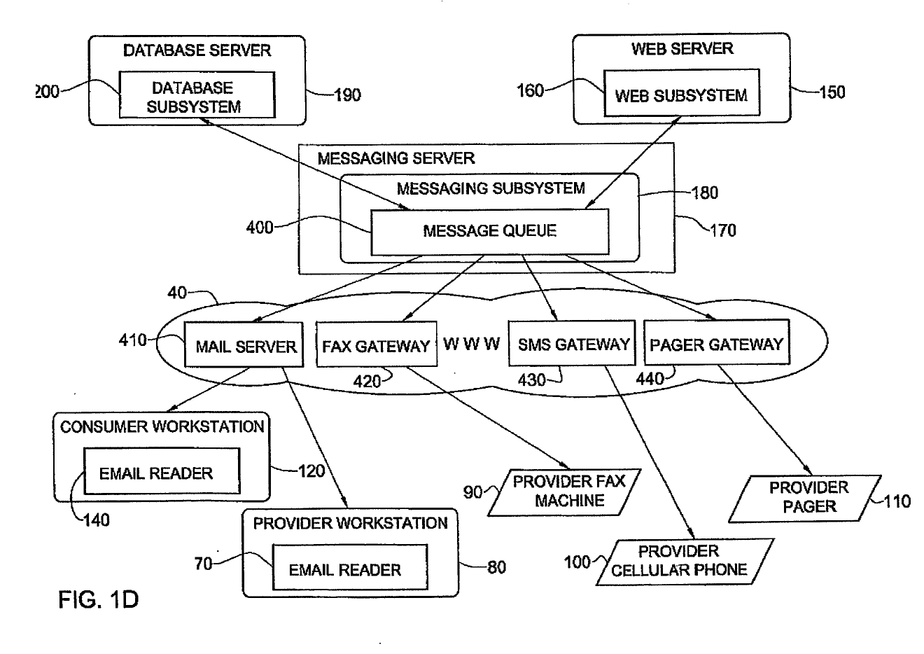

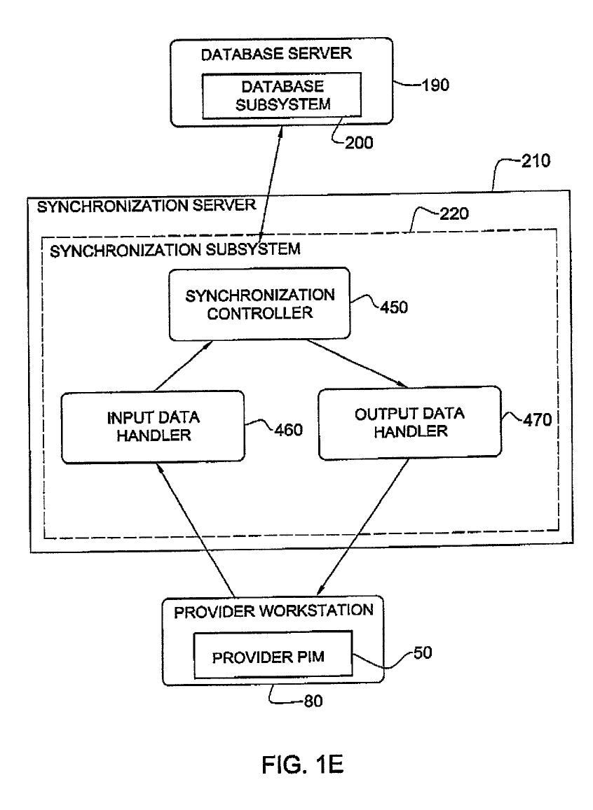

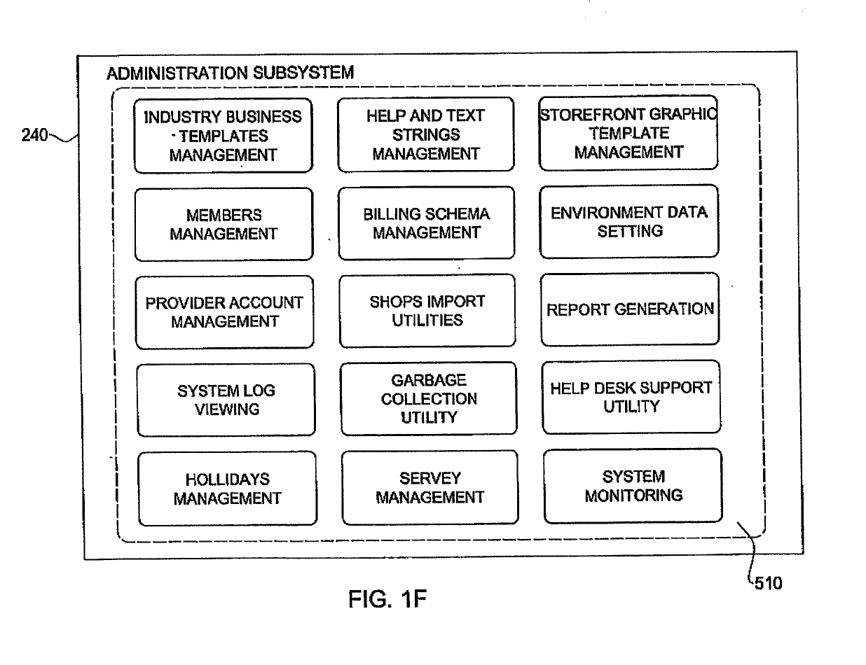

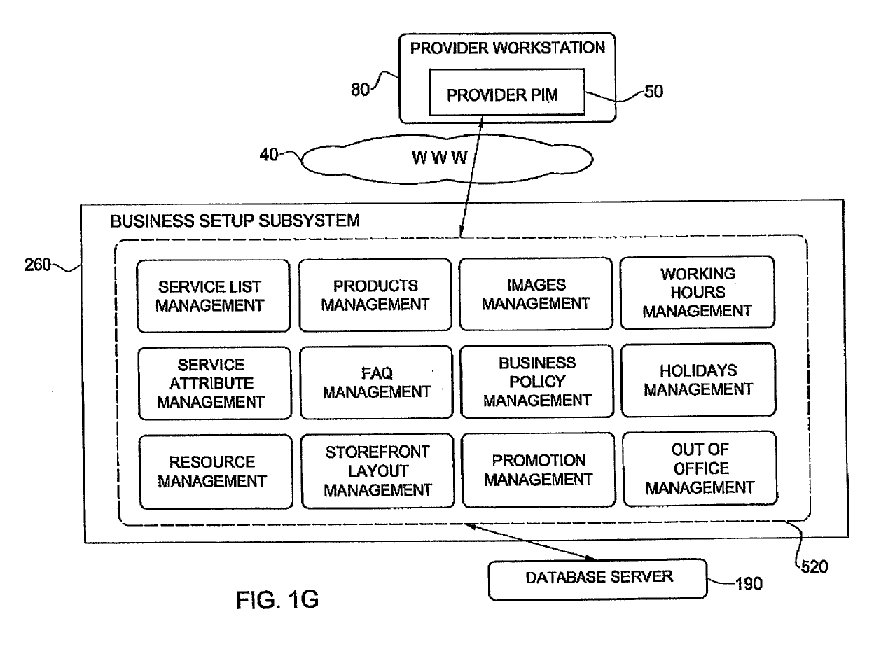

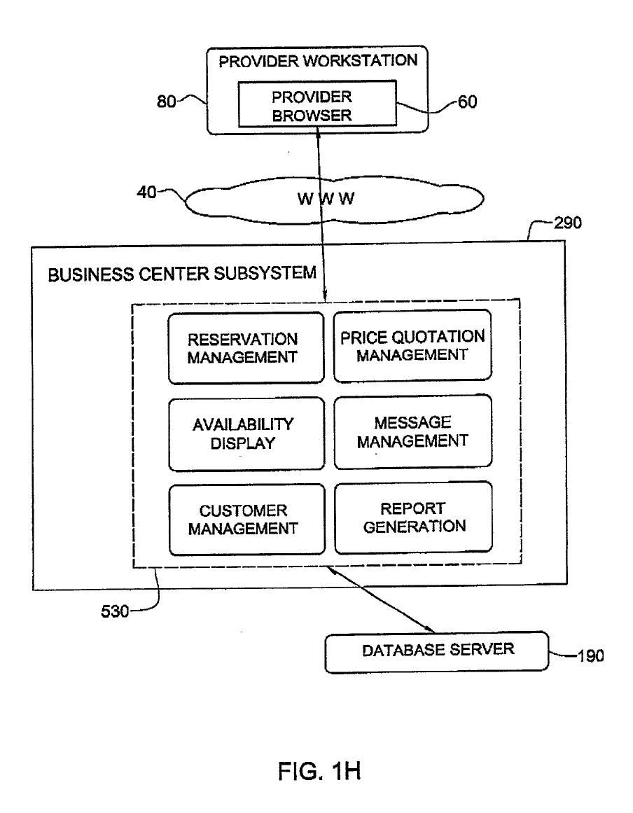

Referring now to the drawings, FIG. 1A illustrates an exemplary computer system in accordance with the present invention that includes a server environment 30 and allows multiple consumers 20 to search services and products providers 10 via a communication network 40. The system may provide the consumers 20 with required services and products depending on their availability and on meeting other criteria that are unique to the required products or services.

Preferably, the communication network 40 is the Internet working with World Wide Web (WWW) interface and utilizing the Internet Protocol (IP), however, the description and concepts equally apply to other public and private computing networks utilizing appropriator communication protocols in which the providers 10 and the consumers 20 are interfaced by the server environment 30.

Referring now to FIG. 1B, it should be appreciated that any number of the consumer 20 and the providers 10 may be interfaced by the server environment 30 though the communication network 40, although for simplicity of illustration, only one of each such stations is explicitly shown.

According to the present invention, each consumer (20 in FIG. 1A) uses a consumer workstation 120 that is any communicating device connected to the system that is capable of running a web browser 130 and email reader 140 through the communication network 40. Each provider (10 in FIG. 1A) uses a provider workstation 80 that is any communicating device connected to the system that is capable of running a web browser 60, email reader 70 and may use a personal information manager (PIM) application, e.g. Microsoft Outlook. Preferably, but not necessarily, for receiving information from the server environment 30 the provider 10 may use a fax 90, a mobile phone 100 and a pager 110.

Such communicating devices of the consumers and providers may be, for example, computers, televisions, hand-held electronic devices, wireless electronic devices, etc.

The server environment 30 includes a web server 150 having a web subsystem 160, a messaging server 170 having a messaging subsystem 180, a synchronization server 210 having a synchronization subsystem 220, an administration server 230 (that may run also as the web server) having administration subsystem 240 and a database server 190 having a database subsystem 240.

According to a preferred embodiment of the invention, all the servers listed above preferably communicate via Local Area Network (LAN) in a typical conventional high availability secured web farm configuration that includes web servers, database servers, file servers (RAID), firewalls, routers, switches and hubs.

It can be appreciated that the web server 150 is the point of entry to substantially, the entire system of the present invention. It determines who the remote user is and makes appropriate decisions while serving information files to the client (consumer 120 or provider 80). The Web server sends the files to the client Workstations, validates user's passwords, sends logging and transaction information to the database server 190, and performs logical operations, thereby also behaving as a transactional server.

The web subsystem 160 of the web server 150 sends client interface information in HTML (Hypertext Markup Language) format and client side scripting to the web browsers 130 and 60 as messages to the Email readers 140 and 70, correspondingly.

According to the preferred embodiment of the invention, the operating system of web server 150 is based on Windows 2000 server. Windows 2000 is a multi-platform operating system provided by Microsoft Corporation of Redmond, Wash. This operating system software provides the performance of the system of the present invention with the greatest potential for growth, as subsequent versions of Windows may become available for new and different kinds of microprocessors.

According to one embodiment of the present invention, implementation of the system of the present invention runs on computers utilizing microprocessors made by Intel Corporation such as Pentium or Xeon. In particular, Xeon based computers can be configured to have more than one microprocessor. This configuration is becoming more common, and since Windows 2000 is an operating system that supports multi-threaded applications it can utilize the full power of dual processor computer systems.

In particular, the web server 150 based on Windows 2000 includes IIS (Internet Information Server), which is a completely integrated Internet application platform.

The IIS includes a high performance web server, an application development environment, integrated full-text searching, multimedia streaming, and site management tools. The security infrastructure is totally integrated with Windows 2000 server, enabling an easy to maintain and highly secure Web development and deployment environment. The IIS also includes support for HTTP byte-range browsers to begin receiving data from any part of a file for enhanced performance. HTTP is a term of art and stands for Hyper-Text Transport Protocol.

Another important factor in deciding to use Windows 2000 is that there is a wealth of available development tools, developer support, and end-product support for this operating system. Microsoft has, by far, the most comprehensive and well-maintained system in place for providing the information and tools necessary to create the planned system of the present invention. In addition, there are many third-party tools available, which will facilitate development.

It should be appreciated that while the preferred embodiment of present invention involves implementing the web server on the basis of Windows 2000 and utilizing Pentium or Xeon computers, the present invention is not bound by these specific operating system and hardware, but can utilize any hardware and/or software platforms that are available for Internet Web services.

The database server 190 operates in collaboration with the web server 150 and maintains all the end users account information, and other associated transaction data as well as all interactions with the Web server that result in a change in the information stored in the database subsystem 200.

As it is known to a man of the art, the disk subsystem (not shown) of the database server 190 is a vulnerable and crucial server element. Hence, due to the mission critical design of this subsystem, it is preferable to utilize a conventional Level 5 RAID. As RAID is an alternative to standard SCSI hard disk drives, a RAID system provides automatic recovery from hard drive failures. Level 5 RAID systems provide the best balance between cost and level of data protection. A Level 5 RAID system uses multiple hard disk drives, on which the stored data is recorded redundantly using a scheme by which the data on the disk can be reconstructed if one of the disk drive units in the RAID fails. In the event of failure, the failed drive can be removed from the RAID system while it is still operating, and a replacement drive can be installed. The RAID system will re-generate the data and return itself to full protection capability. The data stored on the disk subsystem remains available for normal processing, that is from the time the drive failures to the time the RAID system is returned to full protection capability.

The messaging server 170 receives messages from the web server 150 and, in other cases, directly from the database server 190. These messages may be disseminated to the clients (the consumers and providers) in the form of emails, facsimiles, pager massages or short messages to cellular phones. These messages are received, respectively, by the email readers 140, 70; the fax apparatus 90; the pager 110 and by the cellular phone 100.

The basic architecture of the messaging server 210 will be described hereinbelow.

The synchronization server 210 interfaces with the database server 190 at one end and with the provider Personal Information Manager (PIM) 50 of the provider workstation 80 at the other end.

According to the preferred embodiment of the present invention, the synchronization server 210 is designed to carry out the following functions:

(a) synchronizing calendar events and reservations in the PIM 50 of the provider with the corresponding data stored in central database (not shown) of the database server and vice versa;

(b) synchronizing an address book (contact list) in the PIM 50 of the provider with a corresponding customer list stored in the central database;

(c) synchronizing PIM messages of the provider with the messages stored in the central database.

In particular, these capabilities of the synchronization server 210 enable the provider using his PIM calendar to perform safely also off-line reservations to customers (in addition to those that generated their reservations via the web) without the risk of conflict with an existing reservation order in the central database.

According to another embodiment of the present invention, the synchronization server 210 enables also to synchronize web personal schedulers, calendars, and phonebooks, if utilized. Personal schedulers, calendars and phone books are available today not only as applications residing in personal computers but are offered also on some portal web sites as an additional service for their customers. Thus, when the provider 10 confirms a transaction, his personal scheduler, calendar and/or phonebook are updated accordingly. Likewise, the synchronization server 210 will update the customer's calendar, scheduler and/or phonebook to reflect the transaction time and place requirements. The phonebooks are updated to enable both provider and customer to contact each other respectively in case last minute changes to appointment or service need to be made.

The basic architecture and operation of the synchronization server 210 will be described hereinbelow.

The server environment 30 uses a conventional firewall 250 for protection of its resources from users of other networks. This technique is known per se and, therefore, will not be expounded hereinbelow.

Referring now to FIG. 1C, FIG. 1G and FIG. 1H, the web subsystem 160 may call HTML, XML (Extended Markup Language) and ASP (Active Server Pages) 270, 300, 330 scripts and/or COM+ (Component Object Model) components 280, 310, 340 that process information from the end users (providers and consumers). The HTML, XML and ASP files 270, 300, 330 and COM+ components 280, 310, 340 are preferably partitioned into three subsystems included in the web subsystem 160, such as a business setup subsystem 260, a business center subsystem 260 and search subsystem 320.

In operation, the business setup subsystem 260 included in the web subsystem 160 controls interactions of the system with the provider on an initial stage, i.e. when the provider should be specified, and on later stage, when the provider wishes to change the initial setup of his/her e-business. The provider may perform operations (520 in FIG. 1G) that include the following applications:

adding/removing services;

changing the service's attributes;

changing the service's required resources;

managing provider's resources;

changing the service/product pricing schemes;

changing the visual layout of provider's Web storefront,

adding/removing (i) images to be displayed in the storefront, (ii) promotional texts, (iii) contact information, managing provider's working hours and out-of-office hours,

setting (i) provider's business policy regarding customer booking workflow, (ii) notifications policy, (iii) scheduling policy, (iv) calendar preferences, (v) pricing preferences, and

managing Frequently Asked Questions.

The provider Business Setup subsystem 260 automatically configures itself according to the provider's PoS using the aforementioned “social interface” mechanism.

The business center subsystem 290 enables the provider to manage his business and perform operations (530 in FIG. 1H), such as: reservation management, availability display and resource scheduling, price quotation, customer management, message management and reports generation. The Business Center application automatically configures itself according to the provider's PoS using the aforementioned “social interface” mechanism.

According to a preferred embodiment of the invention, there is also a lower level library utilized by Business Center subsystem 290 for generally useful routines (not shown), e.g. interacting with the database and messaging subsystems and performing other generic tasks such as basic date/time calculations. These types of lower level routines are known per se.

The search subsystem 320 is responsible for enabling external web properties such as directories, yellow pages and portals to search for business based on geographic location/distance, availability, pricing, ranking and skill set.

Referring now to FIG. 1D, the messaging subsystem 180 includes a message queue technique 400 that handles the message dissemination in the same order they arrive. The messaging subsystem 180 interfaces with commercial web based gateways 420, 430, 440 and mail servers 410 for communicating the messages via the email readers 140, 70; the fax apparatus 90; the pager 110 and by the cellular phone 100.

Referring now to FIG. 1E, the synchronization subsystem 220 of the synchronization server (210 in FIG. 1B) includes an input data handler 460, an output data handler 470 and a synchronization controller 450.

In operation, the information from the PIM 50 are received by the input data handler 460 and provided to the synchronization controller 450, which relays this information to the database subsystem 200 for storing in the central database. In the reverse order the information retrieved from the database subsystem 200 is received by the synchronization controller 450, which relays this information to the output data handler 470 that provides the messages to the PIM 50.

According to one embodiment of the present invention, whenever the provider (10 in FIG. 1A) selects to synchronize his PIM application 50 with the central database of the database subsystem 200, the synchronization subsystem 220 retrieves provider's locally generated reservations/confirmations (together with their related information) and transforms this information to the central web database. The synchronization subsystem also retrieves the web-generated reservations/confirmations (together with their related information) from the database subsystem 200 and provides this information to a local database of the PIM provider 50.

The synchronization server (210 in FIG. 1B) utilizes an HTTP Request/Response mechanism for transferring information to/from the central database via the web server (150 in FIG. 1B) to the PIM 50. This mechanism is known per se and, therefore, will not be expounded hereinbelow.

Referring now to FIGS. 1B and FIG. 1F, the administrator server 230 is able to communicate directly with the Web server 150 and the database server 190. The administrative subsystem 240 of the administrative server 230 provides administrative capabilities for the entire system. The administrator subsystem 240 allows administrators or other operators of the administrative server 230 to perform routine utility operations 510 that affect the system. Such operations include, but, are not limited to adding and updating providers/consumers records, printing reports, performing backups, and maintaining the programs that comprise the system of the present invention.

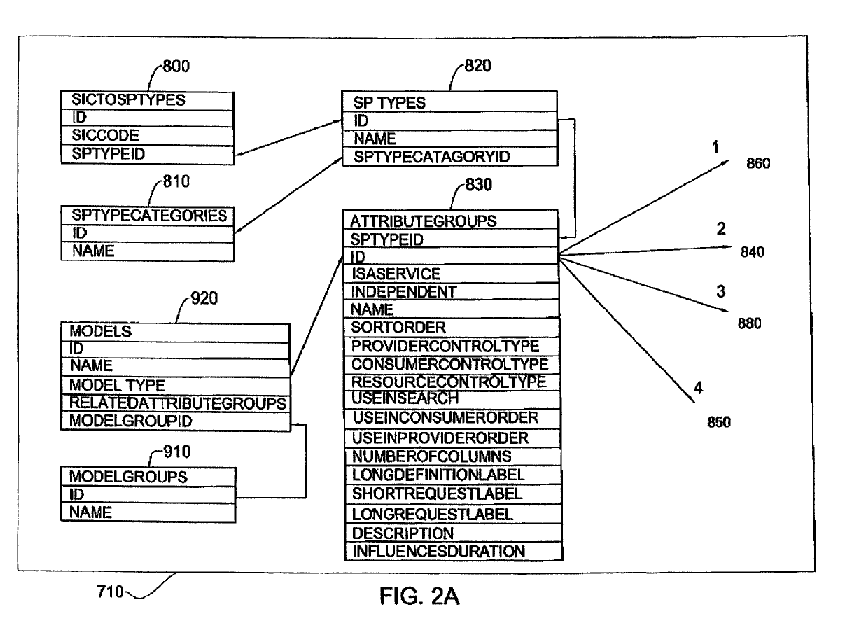

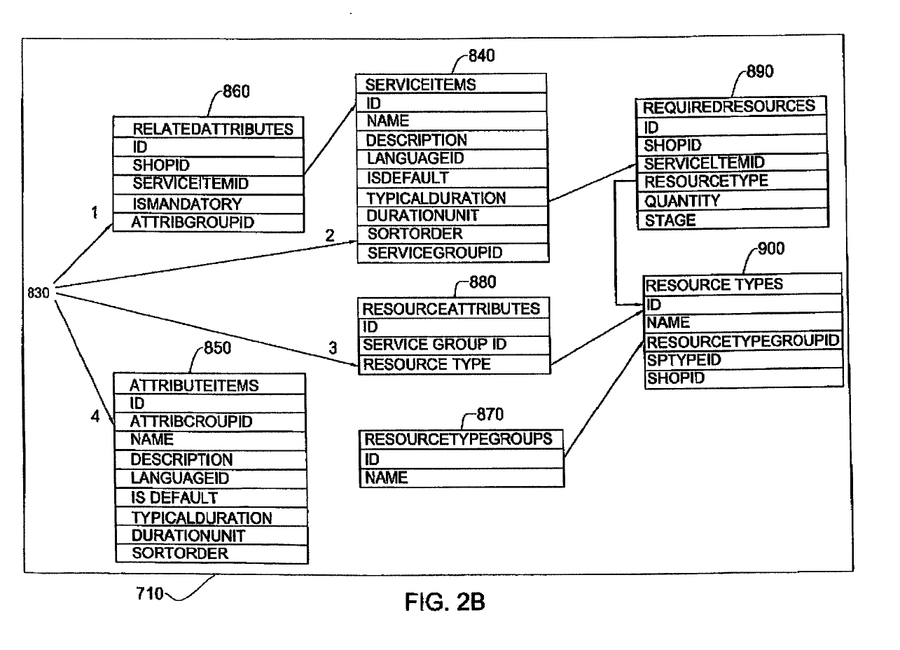

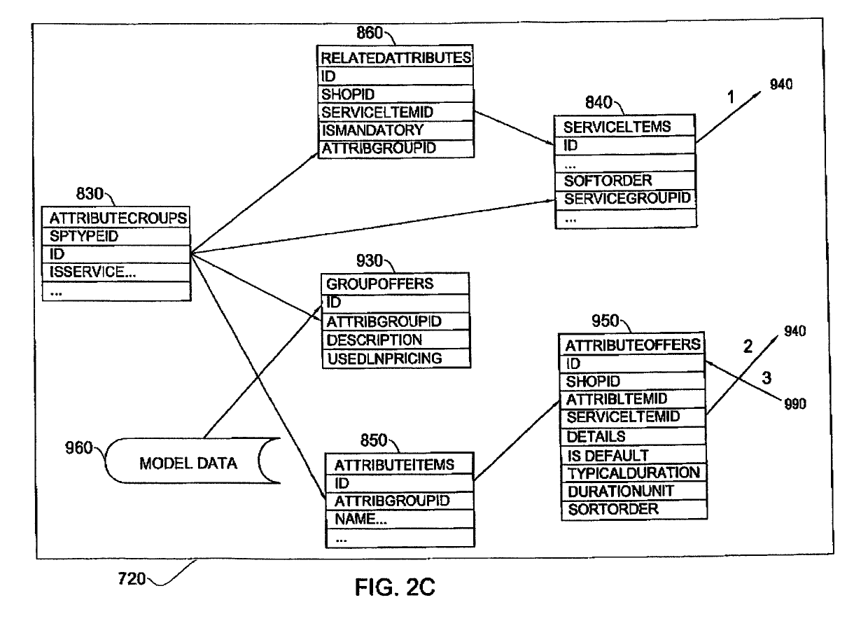

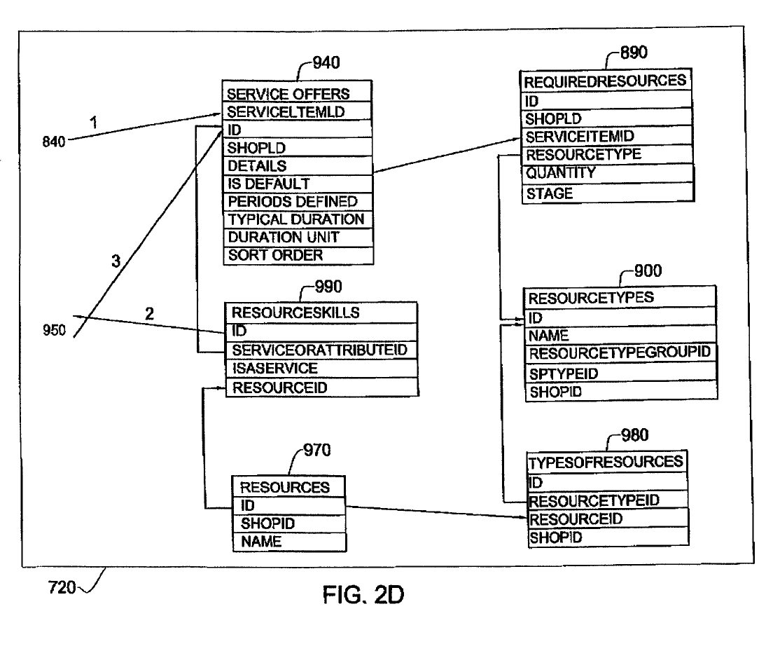

FIG. 2A through FIG. 2D describe the social interface mechanism through description of a few of the main processes of the system.

The system is suited for all PoS types, and adapts its user interface by presenting PoS type-depended user interface, according to the current PoS type. For example, for consumer searching a veterinary, the system presents a search form with specific filter criteria regarding whether a bird or mammal specialist is required, whereas for consumer searching a bed and breakfast, the system presents a search form with e.g. specific filter criteria regarding the necessity of a breakfast and of a TV set.

The database Industry Templates 710 contains PoS-type-depended data for each PoS type (e.g. unique data for plumbers, vets, wedding halls, etc).

The system uses this data in the following main cases:

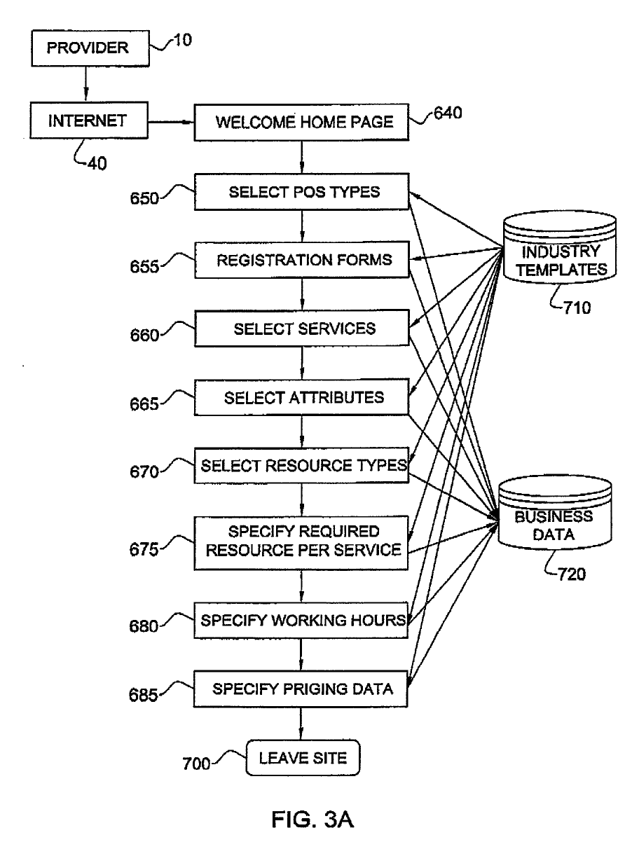

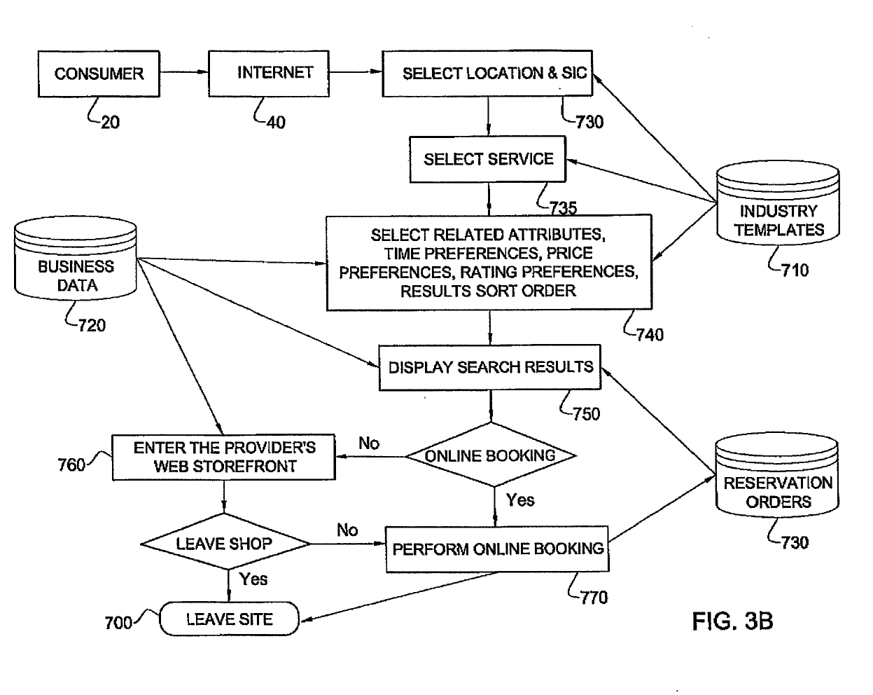

(a) On event of new provider registration—as described in FIG. 3A;

(b) On event of consumer's search for PoS—as described in FIG. 3B;

(c) On event of consumer's booking of PoS time slot—the system combines PoS-type-depended data, as part of the reservation forms;

(d) By this preferred embodiment, Provider Business Setup 260 & Business Center 290 subsystems combines the unique PoS-type-depended data and layout in its user interface.

These cases will be detailed in the following paragraphs. Whilst in this specific embodiment the data are divided into two diagrams (illustrated in FIG. 2A through FIG. 2D), the invention is by no means bound by this manner of data organization. It should be further noted that the entities, and/or relationship appearing in FIG. 2A through FIG. 2D should by no means be regarded as binding and accordingly some may be deleted and/or other may be added all as required and appropriate. Moreover, the invention is not limited to any specific physical or logical realization, and any known per se manner is applicable, e.g. through relational database.

FIG. 2A and continuation in FIG. 2B present a schematic diagram 710 of the main database entities related to the “Social interface” mechanism in accordance with one embodiment of the invention. The figure illustrates the composition of the data entities. The information stored in the following database of the database subsystem (200 in F1B) that is used to model each specific Industry (e.g. Cosmetics, Barbers, Veterinary). This information is not specific for a specific business; it is general for the related industry, therefore this information will be referred to as “Industry templates”.

The following table describes each of the data entities in FIGS. 2A & 2B.

| Entity name | Entity definition |
|---|---|
| SpTypeCategories - | This data entity is used do describe a main line of |
| 810 | business such as: “Health and Beauty”, “Pets”, |
| | “Automotive servies”. |
| SPTypes - 820 | This data entity is used do describe a specific |
| | industry type such as “Massage”, “Veterinary”. |
| | SpType 820 is synonym to PoS. |
| SicToSpTypes - 800 | This data entity is used in order to map SpTypes |
| | 820 to its related SIC (Standard Industry Codes) |
| | codes. |
| AttributeGroup - 830 | This data entity is used in order to describe a |
| | group of services or attributes of service (e.g. |
| | “Massage type”, “Length of treatment”). |
| | Each record in this database table contains |
| | information such as: Descriptions and statements |
| | related to this AttributeGroup 830 that are to be |
| | presented in each of the applications during |
| | different events (such as the required sentences to |
| | be displayed during the business setup or in |
| | reservation forms), what GUI controls should be |
| | used when presenting it, whether or not this |
| | attribute is relevant during a business search, |
| | whether or not this attribute is relevant during a |
| | reservation performed by a consumer, whether or |
| | not this attribute is relevant during a reservation |
| | performed by a provider. |
| ServiceItem - 840 | This data entity is used to describe a specific |
| | service of the group of services (e.g. the specific |
| | “Swedish massage” for the “Massage type” group |
| | of services referred to in 830). |
| | Each record in this database table contains |
| | information such as: the name of the service, its |
| | description, and Its typical duration. |
| | For example a “Pet Examination” service |
| | (serviceItem 840) may typically take 30 minutes. |
| AttributeItem - 850 | This data entity is used to describe a specific |
| | attribute of a service (e.g. “Mail therapist”, |
| | “Dog”). Each record in this database table |
| | contains information such as: the name of the |
| | attribute, its description, and the extra duration |
| | this attribute may impose on the total service |
| | duration. For example a “Pet Examination” |
| | service (ServiceItem 840) that is performed as a |
| | “House Call” (AttributeItem 850) may require |
| | additional time due to the need to drive to and |
| | from the client's house. |
| RelatedAttributes - | This data entity is used to describe the |
| 860 | relationship between a service (ServiceItem 840) |
| | and a group of attributes (AttributeGroup 830). |
| | For each such relationship the data entity |
| | describes whether the relationship is mandatory. |
| | A mandatory relationship between a service and |
| | an attribute group reflects the fact that in case this |
| | service is selected, the person committing this |
| | reservation must also select an attribute from the |
| | related attribute group (e.g. When selecting a |
| | “Swedish massage” ServiceItem 840 you must |
| | also select the “Therapist gender” from the |
| | Therapist gender AttributeGroup 830). |
| | AttributeGroups 830 may also be defined |
| | “independent”, in this case they are not related to |
| | a specific Service rather they are actually related |
| | to all the services in this line of business. For |
| | example the “Massage location” (AttributeGroup |
| | 830) may be defined as “Independent” in this case |
| | no matter what type of treatment you select you |
| | will be asked to specify the location in which you |
| | prefer having the treatment performed. |
| ResourceTypeGroups - | This data entity is used do describe a categories of |
| 870 | resources such as “Personnel”, “Equipment”. |
| ResourceTypes - 900 | This data entity is used do describe a specific type |
| | of resource such as “Massage therapist”, |
| | “Veterinarian”, “Therapy room”, “Truck”. |
| ResourceAttributes - | This data entity is used to describe which |
| 880 | attributes (AttributeGroups 830) must be specified |
| | for each ResourceType 900 when a provider |
| | defined his resources. |
| | It is also used in order to describe which services |
| | (AttributeGroups 830) must be specified for each |
| | ResourceType 900 when a provider defined his |
| | resources. |
| | For example when a business provider describes a |
| | certain “MassageTherapist” (ResourceType 900) |
| | he/she must also specify what Gender the of |
| | therapist (selection from the “Therapist gender” |
| | AttributeGroup 830). He/she must also specify |
| | what types of Massages the therapist is |
| | experienced with (from the “Massage Type” |
| | AttributeGroup 830). |
| RequiredResources - | This data entity is used to describe what quantity |
| 890 | and type of resources (ResourceType 900) are |
| | normally required in order to perform a service |
| | (ServiceItem 840). |
| | For example for a car repair both a mechanic and |
| | a car lift may be required in order to repair |
| | the car. |
| ModelGroups - 910 | This data entity is used to describe a group of |
| | pricing Models 920 from which a provider of a |
| | certain industry will have to choose while setting |
| | up his business through the system. |
| | For example a massage therapist will have to |
| | choose whether he wishes to price his massages |
| | based on the massage length (pricing Model 920) |
| | massage type (pricing Model 920) or based on a |
| | combination of massage length and type (pricing |
| | Model 920). |
| Models - 920 | This data entity is used to describe a specific |
| | pricing Model 920 that may be used in order to |
| | calculate the price of a specific service or |
| | attributes of a service in a specific industry. In |
| | case a provider chooses to use this model he will |
| | have to initialize his “price data” into it, this |
| | additional information set by the provider will be |
| | stored in the ModelData file. Each Model 920 |
| | entity is related to a certain ModelGroup |
| | and is related to a certain ModelType (a |
| | mathematical fromula such as single dimension |
| | lookup table, linear formula, double dimension |
| | lookup table, etc. . .) |
| | For example a massage therapist might want to |
| | use a single dimension lookup table in order to |
| | represent the prices of his massages as a function |
| | of only the massage duration chosen by the |
| | consumer during the reservation. Another |
| | Massage therapist may want to represent the |
| | prices of his massages as a double dimension |
| | lookup table with the massage type representing |
| | the first dimension and the massage duration |
| | representing the second dimension, therefore the |
| | price will be calculated based on both the |
| | massage type and duration chosen by the |
| | consumer during the reservation. |

The following table provides an example of sample attributes of each of the above data entities in the case of the “Massage industry”:

| Entity name | Entity definition |
|---|---|
| SpTypeCategories - | “Health and Beauty” |
| 810 | |
| SpTypes - 820 | “Massage therapy” |
| SicToSpTypes - 800 | This data entity is used in order to map SpTypes 820 |
| | to its related SIC (Standard Industry Codes) codes. |
| AttributeGroup - | “Massage type” |
| 830 | “Length of treatment” |
| | “Therapist gender” |
| | “Massage therapy location” |
| | “Type of oil” |
| ServiceItem - 840 | “Swedish massage type” (related to “Massage |
| | type”) |
| | “Reflexology massage type” (related to “Massage |
| | type”) |
| | “Thai massage type” (related to “Massage type”) |
| | “Indian massage” (related to “Massage type”) |
| AttributeItem - 850 | “30 minutes” (related to “Length of treatment”) |
| | “60 minutes” (related to “Length of treatment”) |
| | “Male therapist” (related to “Therapist gender”) |
| | “Female therapist” (related to “Therapist gender”) |
| | “Office” (related to “Massage therapy location”) |
| | “Client home” (related to “Massage therapy |
| | location”) |
| RelatedAttributes - | “Length of treatment”, “Therapist gender” & |
| 860 | “Massage therapy location” are not related to any |
| | specific “Massage therapy”. |
| | “Type of oil” is related to “Indian massage” |
| ResourceType | “Personnel” |
| Groups - 870 | “Equipment” |
| | “Rooms” |
| ResourceTypes - | “Massage therapist” (related to “Personnel”) |
| 900 | “Therapy room” (related to “Rooms”) |
| ResourceAttributes - | For each “Massage therapist”, the “Therapist |
| 880 | gender” attribute must be defined per (“Length of |
| | treatment” does not have to be defined per |
| | resource). |
| RequiredResources - | “Swedish massage” requires 1 x “Massage |
| 890 | therapist” and 1 x “Therapy room” |
| ModelGroups - 910 | “Massage therapy pricing” |
| Models - 920 | Single dimension lookup table as a function of |
| | “Length of treatment” (e.g. “30 minutes” = $100, |
| | “45 minutes” = $135, “60 minutes” = $140) |
| | Single dimension lookup table for extra payment as |
| | a funciton of “Massage therapy location”[(e.g. |
| | “Office” = no additional money requested, “Client |
| | home” = extra $50) |

The essence of the data model in the current invention for Industry templates is the following:

The data model consists of at least two main segments: Industry Templates 710 and Business Data 720. The Industry templates 710 represent information that is general for each industry and the Business Data 720 represents information that is related to the businesses that chose to register themselves within the system.

The Industry Templates 710 includes at least the following data entities: entities that represent services (ServiceItems 840); entities that represent features or attributes of the requested service (AttributeItems 850); entities that represent the resources required in order to perform the required service(s) (RequiredResources 890); entities or enumerated values that represent types of resources (ResourceTypes 900); entities that represent which features or attributes that are related (during the service ordering process) to each service (RelatedAttributes 860); entities that represent the features or attributes that are relevant (must be specified in the Business Data 720 for any Resource belonging to this ResourceType 900) for each resource type (ResourceAttributes 880); entities that represent which features or attributes influence the pricing (Models 920) and how they influence the pricing.

The Industry Templates 710 includes at least the following relationship between its data entities as described in FIG. 2A & 2B: A relationship of 0 to many (through RelatedAttributes 860 and AttributeGroups 830) between the entities that represent services (ServiceItems 840) and the entities that represent the related features or attributes of the requested service (AttributeItems 850). Put differently, for a given service (in 840) there may be zero or more related attributes that must be specified by the consumer during reservation of any type of service. A relationship of 1 to many between the entities that represent services (ServiceItems 840) and the entities that represent the resources required for performing the required service(s) (RequiredResources 890). Put differently, there may be one or more resource of 1 belonging to 1 or more resource type that is required in order to supply a given service;. A relationship of 0 to many (through ResourceAttributes 880) between the entities that represent types (groups) of features or attributes of the requested service (AttributeGroups 830) and the entities or enumerated values that represent types of resources (ResourceTypes 900). Put differently, for certain attributes (0 or more) it may be required to specify which attribute (0 or more) are supported for each resource (belonging to a certain type of resource) during the business registration/setup, for example for the massage therapist resource type it is required to designate the therapist gender attribute group.

A relationship of 0 to many (through AttributeGroups 830) between the entities that represent features or attributes of the requested service (or services) (AttributeItems 850) and the entities that represent which features or attributes and how they influence the pricing (Models 920). Put differently, zero, one or more service or attribute (e.g. massage type, and massage duration [namely two] both affect the price of a given service; by way of another example only massage duration affects the price, by way of another example the price of any service is a fixed price which is not influenced by any service or attribute). Of course, the pricing model supports more complicated relationships.

FIG. 2C and continuation in FIG. 2D present a schematic diagram 720 of the main database entities related to the implementation of the previously described “Industry templates” by a specific business built with the “Social interface” mechanism. The figure illustrates the composition of the database of the database server 190 that are used to model a specific business (e.g. Veterinary clinic, Automotive garage, Barber shop) and stored in the business data 720 segment of the database.

The following table describes each of the data entities in FIG. 2C & 2D.

| Entity name | Entity definition |
|---|---|
| RelatedAttribues - 860 | This data entity is similar to that described in the |
| | previous table (regarding the Industry templates |
| | 710). In this case the provider (the manager of the |
| | business) can override the default relationship |
| | (defined in the Industry templates) between a |
| | service (ServiceItem 840) he provides and a group |
| | of related attributes (AttributeGroup 830). |
| | For example although in the Industry templates, a |
| | relationship exists between the “Swedish Massage” |
| | (ServiceItem 840) and the “Therapist gender” |
| | attribute (AttributeGroup 830), a provider may |
| | chose to cancel this relationship in his business |
| | because he does not enable his customers select a |
| | male therapist for “Swedish Massage”. Note: this |
| | overridden “dependency” set by the provider is |
| | logically related to the business data 720 segment of |
| | the database although physically stored in the same |
| | database table RelatedAttributes 860 (with a |
| | foreign key “ShopId” that uniquely relates it to a |
| | specific business). |
| GroupOffers - 930 | This data entity is used do indicate that a business |
| | provides a certain group of service (AttributeGroup |
| | 830) or group of Attributes (also AttributeGroup |
| | 830). |
| | Each record in this database table contains |
| | infromation such as: an alternative (other then the |
| | description defined in the Business Templates 710 |
| | in table AttributeGroups 830) description for this |
| | group of services or attributes, an indication |
| | whether or not this group of attributes or services is |
| | related to the pricing of services in this business. |
| | Each record is linked to a specific AttributeGroup |
| | 830 record. |
| ServiceOffer - 940 | This data entity is used do indicate that a business |
| | provides a certain service (ServiceItem 840). |
| | Each record in this database table contains |
| | information such as: an alternative (other then the |
| | description defined in the Business Templates 710 |
| | in table ServiceItems 840) description for this |
| | service, Its typical duration, whether or not it is to |
| | be presented as the default service. Each record is |
| | linked to a specific ServiceItem 840 record. |
| AttributeOffer - 950 | This data entity is used do indicate that a business |
| | provides a certain service attribute (AttributeItem |
| | 850). |
| | Each record in this database table contains |
| | information such as: an alternative (other then the |
| | description defined in the Business Templates 710 |
| | in table AttributeItems 850) description for this |
| | attribute, Its influence on the service extra duration, |
| | whether or not it is to be presented as the default |
| | attribute. Each record is linked to a specific |
| | AttributeItem 850 record. |
| RequiredResources - | This data entity is used to describe what quantity |
| | and type of resources (ResourceType 900) are |
| | normally required in his business in order to perform |
| | a service (ServiceItem 840). |
| | For example in a specific business for a certain car repair |
| | two mechanics and a car lift may be required |
| | in order to repair the car. Note: the information |
| | specified in this data entity set by the provider is |
| | logically related to the business data 720 segment of |
| | the database table RequiredResources 890 (with a |
| | foreign key “ShopId” that uniquely relates it to a |
| | specific business). |
| ModelData - 960 | This data entity is used to store pricing information |
| | set by the provider, which is used by the system to |
| | generate price quotations for service orders |
| | (reservations). |
| | For example a massage therapist might want to use |
| | a single dimension lookup table in order to represent |
| | the prices of his massages as a function of only the |
| | massage duration chosen by the consumer during |
| | the reservation. (e.g. “30 minutes” = $100, “45 |
| | minutes” = $135, “60 minutes” = $140) |
| | Additionally he may want to charge extra money in |
| | case the therapy is performed as a house call (e.g. |
| | “Office” = no additional money requested, “Client |
| | home” = extra $50). |
| | ModelData 960 is physically stored in XML |
| | (Extended Markup Language) files (different files |
| | for each business) and not in database records, due |
| | to the fact that it's structure differs between |
| | different pricing Models 920 used. |

The essence of the data model in the current invention for Business data is the following:

The Business Data 720 includes at least the following data entities: entities that represent which services are provided by each business (ServiceOffers 940), entities that represent which features or attributes of the requested services are provided by each business (AttributeOffers 950), entities that represent the existing resources of the business (Resources 970), entities that represent the capabilities and skills of each resource (ResourceSkills 990), entities that represent the pricing data of the business (ModelData 960).

The Business Data 720 includes at least the following relationship between its data entities: A relationship of 1 to many (through TypesOfResources 980) between the entities that represent resources (Resources 970) and the entities that represent the types of the resources (ResourceTypes 900). A relationship of 1 to many between the entities that represent a resource (Resources 970) and the entities that represent the capabilities and skills of the resource (ResourceSkills 990)

FIG. 3A illustrates a process of a new business registration according to the present invention. This process is activated whenever a new provider wishes to use the system of the present invention, in order to propose his PoS through the system.

In operation, the providers 10 use the web browser (60 in FIG. 1B) for connecting to the Web subsystem (160 in FIG. 1B) through the WWW 40. By working with a simple set of forms, for example, expressed in standard HTML and visible in the web browser, the providers access and manipulate the data stored in the database subsystem (200 in FIG. 1B) for proposing products and/or services.

Upon initiation of the process, the provider is presented with a welcome page 640, where the provider is requested 650 to indicate his PoS types. For example, the indication may be carried out by selection from a predefined list.

As a result, the system presents 655 registration forms, which should be filled out by the provider. The registration forms contain general data, e.g. business name, business address.

Further, the provider is required to select 660 which services or products he/she wishes to provide through the system. For example, the selection may be carried out from a predefined list of services or by adding custom services. For each service or product the provider may set custom data such as description and typical service duration.

Further, the provider is required to select 665 which of the service related attributes are relevant in his business. For example, the selection may also be carried out from a predefined list or by adding custom attributes.

Next, the provider is requested to select 670 what types of each resource are available (e.g. from a predefined list or by adding custom types).

Further, for each service the provider specifies 675 the quantity and types of resources required for performing the service.

Next the provider specifies 680 his regular working hours, out of office periods and holidays.

During the last step 685 the provider specifies pricing details for his services (e.g. what attributes influence the price, in which manner the price is influenced, and the actual prices).

As indicated in FIG. 3A, all the industry related information is read from the industry template 710 that were fed into the system in advance, and all the business specific information is gathered and stored in the business database 720. At the end of this process the new business is registered and ready to be presented and reserved by the consumers.

FIG. 3B illustrates a process of consumer's search for a business and eventually performing online booking of a service. The consumers 20 use the web browser (130 in FIG. 1B) to connect to the Web subsystem 160 through the WWW 40.

The consumer first selects 730 the SIC (Standard Industry Code) and geographic location (Country, State, City, and optionally Zip code) in which he would like to seek a business.

It should be appreciated that the consumer may use, but is not limited to the standard search mechanism of the Web site, which is integrated into the system of the present invention, e.g. Web yellow pages.

As a result of the selection 730 the system provides him with a list of possible services (related to this SIC) grouped according to their AttributeGroups (830 in FIGS. 2A & 2C) from which he must select 735 a service.

As a result of the service selection 735, the system calculates 740 what are the attributes related to the selected service and presents the consumer with a form in which he must select which attributes are relevant for his search.

After filling out the information in the corresponding form and submitting the search, the system displays 750 a list of businesses that perfectly match the consumer's criteria. For each resulting perfectly matched business the system presents general contact information, such as business name and address, together with a list of possible free timeslots from which the consumer may book 770 an appointment through the system along with price estimation for the required service.

In addition the system presents a “hyperlinks” to provider's web Storefronts (also generated by the system) of the resulting businesses. Through this the Storefronts the consumer may find additional information regarding the business or continue booking 770 an appointment online through the system.

Referring back to FIG. 1B, as a result of the searching and booking actions, the system of the present invention may invoke the messaging subsystem 180 in the messaging server 170 to disseminate reservation order records to the appropriate providers. These transmissions may take such forms as Email messages via the email reader 70, fax communications via fax machine 90, voice and short message communications via mobile phone 100, pager notification via pager apparatus 110, and/or HTML based messages displayed on the provider's workstation 80.

As such, those skilled in the art to which the present invention pertains, can appreciate that while the present invention has been described in terms of preferred embodiments, the conception, upon which this disclosure is based, may readily be utilized as a basis for the designing of other structures systems and processes for carrying out the several purposes of the present invention.

It will also be understood that the system according to the invention may be a suitably programmed computer system. Likewise, the invention contemplates a computer program being readable by a computer for executing the method of the invention. The invention further contemplates a machine-readable memory tangibly embodying a program of instructions executable by the machine for executing the method of the invention.

Also, it is to be understood that the phraseology and terminology employed herein are for the purpose of description and should not be regarded as limiting. It is important, therefore, that the scope of the invention is not construed as being limited by the illustrative embodiments set forth herein, but is to be determined in accordance with the appended claims.

1. A computerized method for finding at least one provider that provides resource limited product or service (PoS) through a communication network; the PoS is associated with at least a general criterion and a specific PoS-related criterion; the method comprising:
(One)a customer submitting as an input, through a social interface at least one PoS and associated general and specific PoS-related criterion of interest in respect of each one of said at least one PoS;
(Two) processing the input in order to find the respective contact information of at least one provider that meet said at least one PoS and said at least a general criterion and a specific PoS-related criterion of interest;
(Three) presenting the contact information obtained in step (b).

2. The method of claim 1 further comprising the steps of:
(d) selecting at least one from among said providers and generating a reservation order therefor; and
(e) receiving a status indication in respect of said order; said status indication includes at least confirmation or rejection.

3. The method of claim 1 wherein said general criterion being at least one member selected from the group that includes: SIC (Service Industry Code), location, requested time, time preferences, price range, provider ranking range, previous experience of the consumer with the provider.

4. The method of claim 2 wherein said general criterion being at least one member selected from the group that includes: SIC (Service Industry Code), location, requested time, time preferences, price range, provider ranking range, previous experience of the consumer with the provider.

5. The method of claim 1 wherein wherein said provider is associated with provider resources and wherein said processing step includes checking whether the providers resources meet the specific PoS related criterion and general criterion of the PoS of intererst.

6. The method of claim 2 wherein said provider is associated with provider resources and wherein said processing step includes checking whether the providers resources meet the specific-PoS related criterion and general criterion of the PoS of intererst.

7. The method of claim 1 wherein said specific PoS-related criterion includes at least type of service requested by the Consumer and the service's related features and attributes.

8. The method of claim 1 wherein the submitting step (a) includes the following steps:
(i) providing standard industry code (SIC);
(ii) receiving a list of possible PoS that are related to this SIC; and
(iii) selecting the PoS from said list.

9. The memory medium storing data indicative of a data model for use with the processing step of claim 1, wherein said data model includes at least the following two segments:
(a) Industry Templates representing information that is general for each industry; and
(b) Business Data representing information that is related to the providers that chose to register themselves to provide resource limited product or service (PoS).

10. The memory medium storing data of claim 9 wherein the Industry Templates includes:
entities that represent services; entities that represent features or attributes of the requested service; entities that represent the resources required in order to perform the required service; entities or enumerated values that represent types of resources; entities that represent which features or attributes that are related to each service during the service ordering process; entities that represent which features or attributes influence the pricing and how they influence the pricing; a relationship of 0 to many between the entities that represent services and the entities that represent the related features or attributes of the requested service; a relationship of 1 to many between the entities that represent services and the entities that represent the resources required for performing the required service; a relationship of 0 to many between the entities that represent types (groups) of features or attributes of the requested service and the entities or enumerated values that represent types of resources; a relationship of 0 to many between the entities that represent features or attributes of the requested service and the entities that represent which features or attributes and how they influence the pricing.

11. The memory medium storing data of claim 9 wherein the Business Database includes:
entities that represent which services are provided by each business, entities that represent which features or attributes of the requested services are provided by each business, entities that represent the existing resources of the business, entities that represent the capabilities and skills of each resource, entities that represent the pricing data of the business; a relationship of 1 to many between the entities that represent resources and the entities that represent the types of the resources; a relationship of 1 to many between the entities that represent a resource and the entities that represent the capabilities and skills of the resource.

12. A computerized method for registration at least one provider that provides resource limited product or service (PoS) through a communication network; the PoS is associated with at least a general criterion and a specific PoS-related criterion; the method comprising the steps of:
(One)presenting the provider with a welcome Web page, where the provider is requested to indicate his PoS type;
(Two) indicating the provider's PoS type;
(Three) presenting to the provider a registration form;
(Four) the provider selecting the in the form which services or products he wishes to provide;
(Five) the provider select in the form which of the service's related attributes are relevant in his business for each PoS;
(Six) the provider specifying in the form what types of resource required for each PoS;
(Seven) the provider specifying in the form his working hours;
(Eight) the provider specifying in the form a way of pricing.

13. A computerized system for finding at least one provider that provides resource limited product or service (PoS) through a communication network; the PoS is associated with at least a general criterion and a specific PoS-related criterion; the system comprising:
(One)at least one customer workstation linked to said communication network, configured to submit as an input through a social interface, at least one PoS and associated general and specific PoS-related criterion of interest in respect of each one of said at least one PoS;
(Two) a server environment linked to said communication network, configured to process the input in order to find the respective contact information of at least one provider that meet the at least one PoS and said at least a general criterion and a specific PoS-related criterion of interest;
(Three) said customer workstation being further configured to present the contact information obtained in step (b).

14. The system of claim 13 wherein
(a) in response to selecting at least one from among said providers, the server environment is configured to generate a reservation order therefor; and
(b) said at least one consumer workstation is further configured to receive a status indication in respect of said order; said status indication includes at least confirmation or rejection.

15. For use in the system of claim 13, a consumer workstation.

16. For use in the system of claim 13, a server environment.

17. A memory medium storing data indicative of a data model for use with the system of claim 13, the data model including at least the following two segment:
(a) Industry Templates representing information that is general for each industry; and
(b) Business Data representing information that is related to the providers that chose to register themselves to provide resource limited product or service (PoS).

18. The memory medium storing data of claim 17 wherein the Industry Templates includes:
entities that represent services; entities that represent features or attributes of the requested service; entities that represent the resources required in order to perform the required service; entities or enumerated values that represent types of resources; entities that represent which features or attributes that are related to each service during the service ordering process; entities that represent which features or attributes influence the pricing and how they influence the pricing; a relationship of 0 to many between the entities that represent services and the entities that represent the related features or attributes of the requested service; a relationship of 1 to many between the entities that represent services and the entities that represent the resources required for performing the required service; a relationship of 0 to many between the entities that represent types (groups) of features or attributes of the requested service and the entities or enumerated values that represent types of resources; a relationship of 0 to many between the entities that represent features or attributes of the requested service and the entities that represent which features or attributes and how they influence the pricing.

19. The memory medium storing data of claim 17 wherein the Business Database includes:
entities that represent which services are provided by each business, entities that represent which features or attributes of the requested services are provided by each business, entities that represent the existing resources of the business, entities that represent the capabilities and skills of each resource, entities that represent the pricing data of the business; a relationship of 1 to many between the entities that represent resources and the entities that represent the types of the resources; a relationship of 1 to many between the entities that represent a resource and the entities that represent the capabilities and skills of the resource.

20. The method of claim 1 wherein said communication network is the Internet.

21. The method of claim 21 wherein the Internet utilizes the World Wide Web (WWW) interface having a Web browser.

22. A web integrated computer system for searching resource limited product or service (PoS) on the Web; the PoS is associated with general criteria that include at least availability data, and specific criteria related to the type of the Pos; the system comprising:
(One)browser operative to search the web, through social interface, PoS that meet a general filter criteria that include desired resource indication, and specific filter criteria;
(Two) the browser obtaining resulting PoS having general criteria and specific criteria that match said general filter criteria and specific filter criteria; said matched PoS having availability that matches the desired resource indication;
(Three) the browser receiving selection of at least one from among said resulting PoS and generating a reservation order therefor.

23. The system of claim 23 further comprising means for receiving status indication in respect of said order; said status indication includes at least confirmation or rejection.

24. The system according to claims 23 wherein said resource limited PoS being time-sharing based PoS and wherein said desired resource indication being timing indication.

25. The system according to claim 23 wherein a portal or service provider in said web integrated computer system is fitted with a Web-based-service provider server, a synchronization server; an availability booking server and a search engine, all associated with a database.

26. For use in the system of claims 40, a social interface.

27. A computerized program storage device readable by machine, tangibly embodying a program of instructions executable by the machine to perform method steps for finding at least one provider that provides resource limited product or service (PoS) through a communication network; the PoS is associated with at least a general criterion and a specific PoS-related criterion; the method comprising:
(One)a customer submitting as an input, through a social interface at least one PoS and associated general and specific PoS-related criterion of interest in respect of each one of said at least one PoS;
(Two) processing the input in order to find the respective contact information of at least one provider that meet said at least one PoS and said at least a general criterion and a specific PoS-related criterion of interest;
(Three) presenting the contact information obtained in step (b).

28. A computerized computer program product comprising a computer useable medium having computer readable program code embodied therein for finding at least one provider that provides resource limited product or service (PoS) through a communication network; the PoS is associated with at least a general criterion and a specific PoS-related criterion; the computer program product comprising:
computer readable program code for causing the computer to a customer submitting as an input, through a social interface at least one PoS and associated general and specific PoS-related criterion of interest in respect of each one of said at least one PoS;
computer readable program code for causing the computer to process the input in order to find the respective contact information of at least one provider that meet said at least one PoS and said at least a general criterion and a specific PoS-related criterion of interest;
computer readable program code for causing the computer to present the contact information obtained in step (b).

29. A computerized program storage device readable by machine, tangibly embodying a program of instructions executable by the machine to perform method steps for registration at least one provider that provides resource limited product or service (PoS) through a communication network; the PoS is associated with at least a general criterion and a specific PoS-related criterion; the method comprising the steps of:
(One)presenting the provider with a welcome Web page, where the provider is requested to indicate his PoS type;
(Two) indicating the provider's PoS type;
(Three) presenting to the provider a registration form;
(Four) the provider selecting the in the form which services or products he wishes to provide;
(Five) the provider select in the form which of the service's related attributes are relevant in his business for each PoS;
(Six) the provider specifying in the form what types of resource required for each PoS;
(Seven) the provider specifying in the form his working hours;
(Eight) the provider specifying in the form a way of pricing.

30. A computerized computer program product comprising a computer useable medium having computer readable program code embodied therein for registration at least one provider that provides resource limited product or service (PoS) through a communication network; the PoS is associated with at least a general criterion and a specific PoS-related criterion; the computer program product comprising:
computer readable program code for causing the computer to present the provider with a welcome Web page, where the provider is requested to indicate his PoS type;
computer readable program code for causing the computer to indicate the provider's PoS type;
computer readable program code for causing the computer to present to the provider a registration form;
computer readable program code for causing the computer to the provider selecting the in the form which services or products he wishes to provide;
computer readable program code for causing the computer to the provider select in the form which of the service's related attributes are relevant in his business for each PoS;
computer readable program code for causing the computer to the provider specifying in the form what types of resource required for each PoS;
computer readable program code for causing the computer to the provider specifying in the form his working hours;
computer readable program code for causing the computer to the provider specifying in the form a way of pricing.
